(19) United States
(12) Patent Application Publication
(10) Pub. No.: US 2012/0224498 A1
(43) Pub. Date: Sep. 6, 2012

(54) BAYESIAN PLATFORM FOR CHANNEL ESTIMATION

(75) Inventors: Farrokh Abrishamkar, San Diego, CA (US); Miriam Motamed, Santa Clara, CA (US); Ali Yazdan Panah, Santa Clara, CA (US); Parvathanathan Subrahmanya, Santa Clara, CA (US); Amir Farajidana, Santa Clara, CA (US); Dinesh Krithivasan, Santa Clara, CA (US); Kenneth Kreutz-Delgado, San Diego, CA (US)

(73) Assignee: QUALCOMM INCORPORATED, San Diego, CA (US)

(21) Appl. No.: 13/040,824

(22) Filed: Mar. 4, 2011

(51) Int. Cl. H04L 12/26

(52) U.S. Cl. 370/252

(57) ABSTRACT

Certain aspects of the present disclosure propose a method for estimating a channel utilizing Sparse Bayesian Learning (SBL) algorithm. The proposed method employs a Basis expansion (e.g., polynomial) channel model, and iteratively performs SBL algorithm to adjust parameters of the channel model.

### TECHNICAL FIELD

Certain aspects of the present disclosure generally relate to wireless communications and, more particularly, to systems and methods for estimating a wireless channel in a wireless communications system.

### BACKGROUND

The third Generation Partnership Project (3GPP) Long Term Evolution (LTE) represents a major advance in cellular technology and is the next step forward in cellular 3G services as a natural evolution of Global System for Mobile Communications (GSM) and Universal Mobile Telecommunications System (UMTS). LTE provides for an uplink speed of up to 50 megabits per second (Mbps) and a downlink speed of up to 100 Mbps and brings many technical benefits to cellular networks. LTE is designed to meet carrier needs for high-speed data and media transport as well as high-capacity voice support well into this decade. Bandwidth is scalable from 1.25 MHz to 20 MHz. This suits the needs of different network operators that have different bandwidth allocations, and also allows operators to provide different services based on spectrum. LTE is also expected to improve spectral efficiency in 3G networks, allowing carriers to provide more data and voice services over a given bandwidth. LTE encompasses high-speed data, multimedia unicast and multimedia broadcast services.

Physical layer (PHY) of the LTE standard is a highly efficient means of conveying both data and control information between an enhanced base station (eNodeB) and mobile user equipment (UE). The LTE PHY employs Multiple Input Multiple Output (MIMO) data transmission. In addition, the LTE PHY uses Orthogonal Frequency Division Multiple Access (OFDMA) on the downlink (DL) and Single Carrier-Frequency Division Multiple Access (SC-FDMA) on the uplink (UL). OFDMA allows data to be directed to or from multiple users on a subcarrier-by-subcarrier basis for a specified number of symbol periods.

LTE-Advanced is an evolving mobile communication standard for providing fourth generation (4G) services providing peak data rates up to 1 Gbit/s. LTE-Advanced also targets faster switching between power states and improved performance at the cell edge.

### SUMMARY

Certain aspects of the present disclosure provide a method for estimating a channel in a wireless communications system. The method generally includes obtaining a channel model utilizing basis expansion algorithm, initializing one or more parameters of the channel model, and iteratively performing Sparse Bayesian Learning (SBL) algorithm to adjust the parameters of the channel model, wherein the SBL algorithm utilizes reference signals.

Certain aspects of the present disclosure provide an apparatus for estimating a channel in a wireless communications system. The apparatus generally includes means for obtaining a channel model utilizing basis expansion algorithm, means for initializing one or more parameters of the channel model, and means for iteratively performing Sparse Bayesian Learning (SBL) algorithm to adjust the parameters of the channel model, wherein the SBL algorithm utilizes reference signals.

Certain aspects provide a computer-program product for estimating a channel in a wireless communications system, comprising a computer-readable medium having instructions stored thereon, the instructions being executable by one or more processors. The instructions generally include instructions for obtaining a channel model utilizing basis expansion algorithm, instructions for initializing one or more parameters of the channel model, and instructions for iteratively performing Sparse Bayesian Learning (SBL) algorithm to adjust the parameters of the channel model, wherein the SBL algorithm utilizes reference signals.

Certain aspects of the present disclosure provide an apparatus for estimating a channel in a wireless communications system. The apparatus generally includes at least one processor configured to obtain a channel model utilizing basis expansion algorithm, initialize one or more parameters of the channel model, and iteratively perform Sparse Bayesian Learning (SBL) algorithm to adjust the parameters of the channel model, wherein the SBL algorithm utilizes reference signals, and a memory coupled to the at least one processor.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a multiple access wireless communication system, in accordance with certain aspects of the present disclosure.

FIG. 2 illustrates a block diagram of a communication system, in accordance with certain aspects of the present disclosure.

FIGS. 3A and 3B illustrate two example block diagrams of a proposed sparse Bayesian learning (SBL) channel estimation algorithm, in accordance with certain aspects of the present disclosure.

FIG. 4 illustrates an example block diagram of the proposed SBL channel estimation algorithm in stacked mode, in accordance with certain aspects of the present disclosure.

FIG. 5 illustrates an example block diagram of the proposed SBL channel estimation algorithm in single mode, in accordance with certain aspects of the present disclosure.

FIG. 6 illustrates example operations for the proposed SBL channel estimation algorithm, in accordance with certain aspects of the present disclosure.

FIG. 7 illustrates the SBL algorithm, in accordance with certain aspects of the present disclosure.

FIG. 8 illustrates an example block diagram of the proposed SBL channel estimation algorithm, in accordance with certain aspects of the present disclosure.

FIG. 9 illustrates a block diagram of the proposed SBL channel estimation algorithm, in accordance with certain aspects of the present disclosure.

FIG. 10 illustrates an example functional block diagram of a wireless device capable of performing the SBL channel estimation, in accordance with certain aspects of the present disclosure.

### DETAILED DESCRIPTION

Various aspects are now described with reference to the drawings. In the following description, for purposes of explanation, numerous specific details are set forth in order to provide a thorough understanding of one or more aspects. It may be evident; however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA 2000, etc. UTRA includes Wideband-CDMA (W-CDMA). CDMA2000 covers IS-2000, IS-95 and IS-856 standards. A TDMA network may implement a radio technology such as Global System for Mobile Communications (GSM).

An OFDMA network may implement a radio technology such as Evolved UTRA (E-UTRA), The Institute of Electrical and Electronics Engineers (IEEE) 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a recent release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ratio (PAPR) because of its inherent single carrier structure. SC-FDMA may be used in the uplink communications where lower PAPR greatly benefits the mobile terminal in terms of transmit power efficiency. SC-FDMA is currently a working assumption for uplink multiple access scheme in 3GPP Long Term Evolution (LTE), or Evolved UTRA.

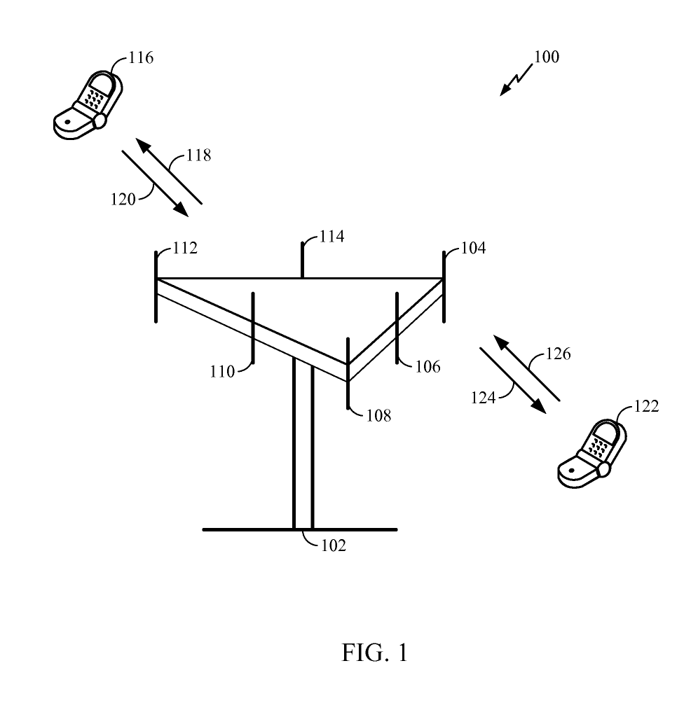

Referring to FIG. 1, a multiple access wireless communication system 100 according to one aspect is illustrated. An access point 102 (AP) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In a Frequency Division Duplex (FDD) system, communication links 118, 120, 124 and 126 may use a different frequency for communication. For example, forward link 120 may use a different frequency than that used by reverse link 118.

Each group of antennas and/or the area in which they are designed to communicate is often referred to as a sector of the access point. In an aspect, antenna groups each are designed to communicate to access terminals in a sector of the areas covered by access point 102. For certain aspects, the access point may estimate the communication channel from each of the terminals 116, 122 using a sparse Bayesian learning (SBL) channel estimation method, as described in further detail below.

In communication over forward links 120 and 126, the transmitting antennas of access point 102 may utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as a Node B, an evolved Node B (eNB), or some other terminology.

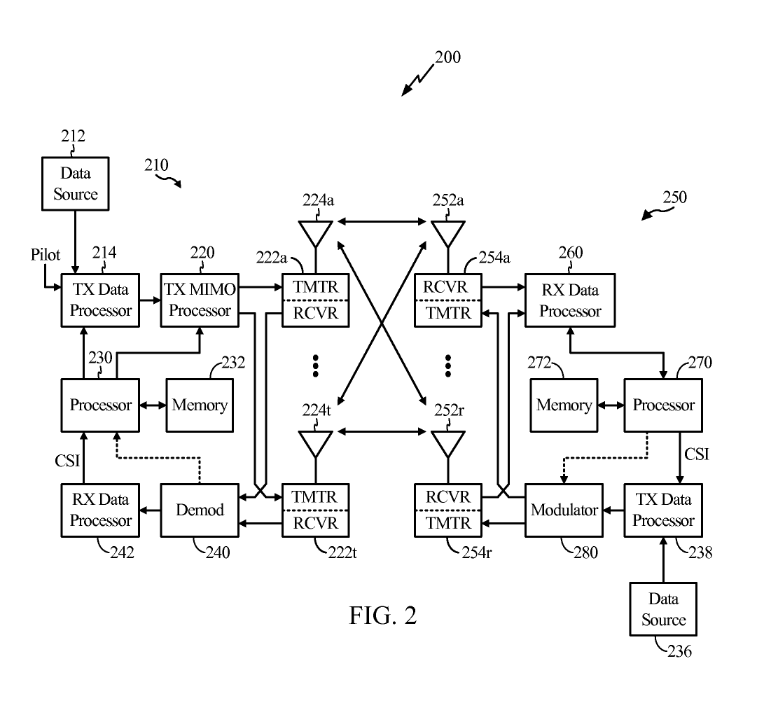

FIG. 2 is a block diagram of an aspect of a transmitter system 210 and a receiver system 250 in a MIMO system 200. At the transmitter system 210, traffic data for a number of data streams is provided from a data source 212 to a transmit (TX) data processor 214.

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., Binary Phase Shift Keying (BPSK), Quadrature Phase Shift Keying (QPSK), M-PSK in which M may be a power of two, or M-QAM (Quadrature Amplitude Modulation)) selected for that data stream to provide modulation symbols. The data rate, coding and modulation for each data stream may be determined by instructions performed by processor 230 that may be coupled to a memory 232.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves and decodes each detected symbol stream to recover the traffic data for the data stream. The processing by RX data processor 260 is complementary to that performed by TX MIMO processor 220 and TX data processor 214 at transmitter system 210.

Processor 270, coupled to a memory 272, formulates a reverse link message. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240 and processed by a RX data processor 242 to extract the reserve link message transmitted by the receiver system 250. The RX data processor 242 may also estimate the communication channel and send channel state information (CSI) to the processor.

Certain aspects of the present disclosure propose a method for estimating a channel utilizing Sparse Bayesian Learning (SBL) algorithm. The proposed method may employ a Basis expansion channel model (e.g., Tap Polynomial channel model) as described in a commonly-owned U.S. patent application Ser. No. 12/950,452, entitled “Apparatus and Method for Compressing Sensing Tap Identification for Channel Estimation”, filed Nov. 19, 2010. The proposed SBL channel estimation has superior performance compared to conventional channel estimation algorithms such as minimum means squared error (MMSE). The SBL channel estimation algorithm may not need prior knowledge of the channel (e.g., Doppler).

Certain wireless channels such as orthogonal frequency division multiplexing (OFDM) channels in the LTE standard exhibit sparsity. Examples of such sparse channels may include extended pedestrian A (EPA), extended vehicular A (EVA), and extended typical urban (ETU) channel models. However, conventional channel estimation algorithms based on the MMSE algorithm do not exploit sparsity. The proposed channel estimation algorithm utilizes the SBL algorithm to estimate a communication channel by exploiting channel sparsity inherent to such multi-path wireless channels. By taking advantage of sparsity of a channel, performance of the channel estimation algorithm may be improved.

The proposed SBL channel estimation results in improved block error rate (BLER) and channel mean square error (MSE) compared to other channel estimation algorithms such as the least absolute shrinkage and selection operator (LASSO) MMSE based estimation techniques. The performance gain of the SBL channel estimation compared to the LASSO technique is greater at high Doppler values. In addition, the proposed method may not use power intensive FFT operations. The SBL channel estimation technique utilizes a simple iterative algorithm, does not need convex optimization, performs a sequence of linear operations, has a fast convergence, and does not need prior knowledge about the channel.

For certain aspects, the SBL channel estimation may be initialized with a set of constant values, random numbers or with prior values from other available channel estimation algorithms, such as MMSE. Current state of the channel estimation may be used as prior values for the next sub-frame.

For certain aspects, two different approaches (e.g., stacked or single) may be utilized to estimate a channel using the SBL algorithm. In the ‘stacked’ approach, the wireless channel may be modeled using basis expansion model, and SBL technique may be applied for channel recovery (e.g., estimation) using all OFDM reference (pilot) symbols available in a subframe. Hence, the stacked approach operates on a block of reference signals at a time. In the ‘single’ approach, the SBL technique may be applied for channel recovery per OFDM pilot symbol, followed by time interpolation. Since the stacked approach operates on a block of data, it may be slower but may have higher gain compared to the single approach.

For certain aspects, all of the available pilot tones may be utilized for channel estimation (e.g., sparse recovery). In another aspect, a subset of the available pilot tones may be utilized for channel recovery (e.g., compressed sensing) to reduce computational complexity. It should be noted that the compressed sensing approach may have smaller gain and less computations compared to the sparse recovery approach. For certain aspects, the subset of pilot tones may be selected randomly. For another aspect, the subset of pilot tones may be selected based on the order in which the pilot tones are structured.

### Mathematical Description

A Tap Polynomial channel Model may be utilized to model channel impulse response at time t of length L as follows:

$${h}_{l} ( t ) = [ \begin{matrix}{h}_{0} ( t ) \\ ⋮ \\ {h}_{p} ( t ) \\ ⋮ \\ {h}_{L - 1} ( t )\end{matrix} ] \qquad Eq n ( 1 )$$

where L represents the cyclic prefix length.

By utilizing Taylor series basis expansion in time, the channel response may be written in vector form, as follows:

$$\begin{matrix}{h}_{l} ( t ) = [ \begin{matrix}{\sum }_{q = 0}^{Q - 1} {c}_{0 , q} {u}_{q} ( t ) \\ ⋮ \\ {\sum }_{q = 0}^{Q - 1} {c}_{l , q} {u}_{q} ( t ) \\ ⋮ \\ {\sum }_{q = 0}^{Q - 1} {c}_{L - 1 , q} {u}_{q} ( t )\end{matrix} ] \\ = {\sum }_{q = 0}^{Q - 1} [ \begin{matrix}{c}_{0 , q} \\ ⋮ \\ {c}_{l , q} \\ ⋮ \\ {c}_{L - 1 , q}\end{matrix} ] {u}_{q} ( t ) \\ = {\sum }_{q = 0}^{Q - 1} {c}_{q} {u}_{q} ( t ) \\ = [ {c}_{0} , … , {c}_{Q - 1} ] [ \begin{matrix}{u}_{0} ( t ) \\ ⋮ \\ {u}_{Q - 1} ( t )\end{matrix} ] {u}_{q} ( t ) \\ = {\sum }_{q = 0}^{Q - 1} {c}_{q} {u}_{q} ( t ) \\ = {Cu ( t )}^{T} \\ = ( u ( t ) ⊗ {I}_{L} ) vec ( C ) \\ = U ( t ) c\end{matrix} \qquad Eqn ( 2 )$$

in which u(t)=└u₀(t), . . . , u_{Q-1}(t)┘ may represent a basis function, c may represent desired channel coefficients, Q represents Taylor series polynomial order, I_{L} represents the identity matrix, vec(.) represents vectorization of coefficients c_{l,q}, and \textcircled{X} denotes the Kronecker product.

Frequency response H(t) of the channel may be derived as follows:

H(t)=Fhₗ(t)=FU(t)c Eqn (3)

in which F may represent the DFT matrix.

For the pilot signals, the channel frequency response may be written as follows:

Hₚ(t)=Sₚ(t)FU(t)c,

in which Sₚ(t) is a sampling vector used to select desired pilot tones.

Several observations (or reference symbols) may be stacked in time to generate a stacked measurement vector y, as follows:

$$y = [ \begin{matrix}{H}_{p} ( 0 ) \\ ⋮ \\ {H}_{p} ( K - 1 )\end{matrix} ] = [ \begin{matrix}{S}_{p} ( 0 ) FU ( 0 ) c \\ ⋮ \\ {S}_{p} ( K - 1 ) FU ( K - 1 ) c\end{matrix} ] = S Ψ c + n \\ S = {[ \begin{matrix}{s}_{p} ( 0 ) & … & 0 \\ ⋮ & ⋱ & ⋮ \\ 0 & … & {s}_{p} ( T - 1 )\end{matrix} ]}_{MT \times NT} , \\ Ψ = {[ \begin{matrix}FU ( 0 ) \\ ⋮ \\ FU ( T - 1 )\end{matrix} ]}_{NT \times LQ} \qquad Eqn ( 4 )$$

in which S may represent an MT×NT sampling matrix, M represents the number of utilized pilot tones, T represents the number of observations, N represents the total number of subcarriers, n may represent noise, and Ψ may represent an NT×LQ basis function.

The channel matrix A may be calculated as follows:

A=SΨ Eqn (5)

For certain aspects, in order to estimate a channel, a basis function Ψ may be selected by utilizing Taylor series expansion. The channel parameters may be calculated by performing SBL algorithm on the channel model (e.g., y=SΨc+n). The sampling matrix S may be selected randomly. The Taylor series expansion may be written as follows:

$${u}_{q} ( t ) = {t}^{q} -> u ( t ) = [ \begin{matrix}{t}^{0} \\ {t}^{1} \\ ⋮ \\ {t}^{Q - 1}\end{matrix} ] ⇒ Ψ = FU$$

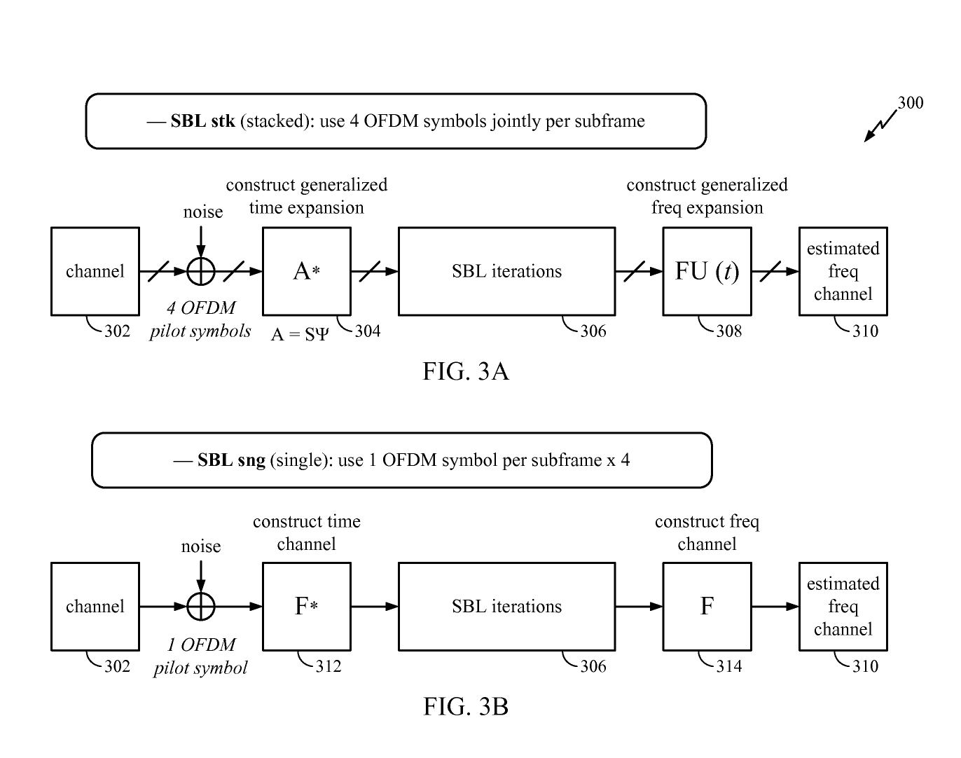

FIGS. 3A and 3B illustrate two example block diagrams for the proposed SBL channel estimation algorithm. FIG. 3A illustrates an SBL stacked mode, which may use a plurality of OFDM symbols per subframe as an input. As illustrated, a signal that may include pilot symbols may be received from a channel 302. The pilot symbols may be used to construct generalized time expansion matrix A* 304. The SBL algorithm 306 may iteratively operate on the A* to calculate the channel coefficients c. The results may be used to construct generalized frequency expansion (e.g., FU(t)) 308. The estimated channel 310 may then be calculated from FU(t).

FIG. 3B illustrates a single mode of the SBL channel estimation algorithm. The single mode may utilize a single reference OFDM symbol per subframe at a time. As illustrated, a noisy signal that may include pilot symbols may be received from the channel 302. The signal may be used to construct time channel (F*) 312. The SBL algorithm 306 may iteratively operate on the F* to calculate the channel coefficients c. The calculated coefficients may be used to construct frequency channel (F) 314. The estimated channel 310 may then be calculated from F.

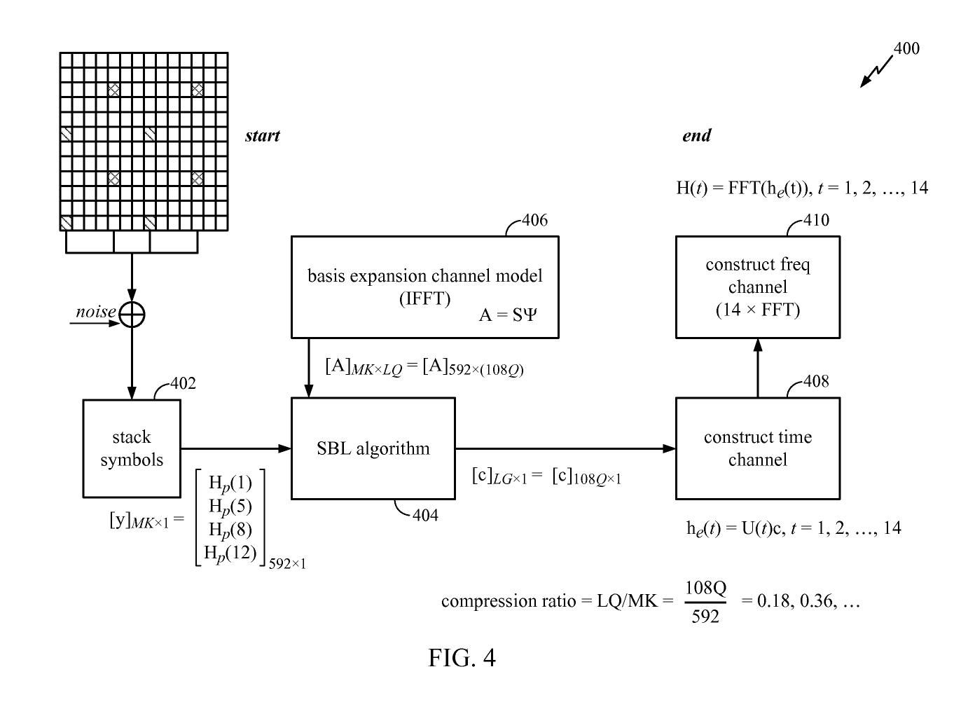

FIG. 4 illustrates an example block diagram 400 of the SBL channel estimation algorithm in stacked mode in more detail. As illustrated, a plurality of OFDM pilot symbols may be stacked together to generate a stacked measurement vector y 402. The SBL algorithm 404 may operate on the stacked measurement vector using a basis expansion channel model 406 to generate channel coefficients c. The coefficients c may be used to construct channel hₗ(t) 408 in time domain. Utilizing fast Fourier transform (FFT) 410, the estimated channel may be converted to frequency domain.

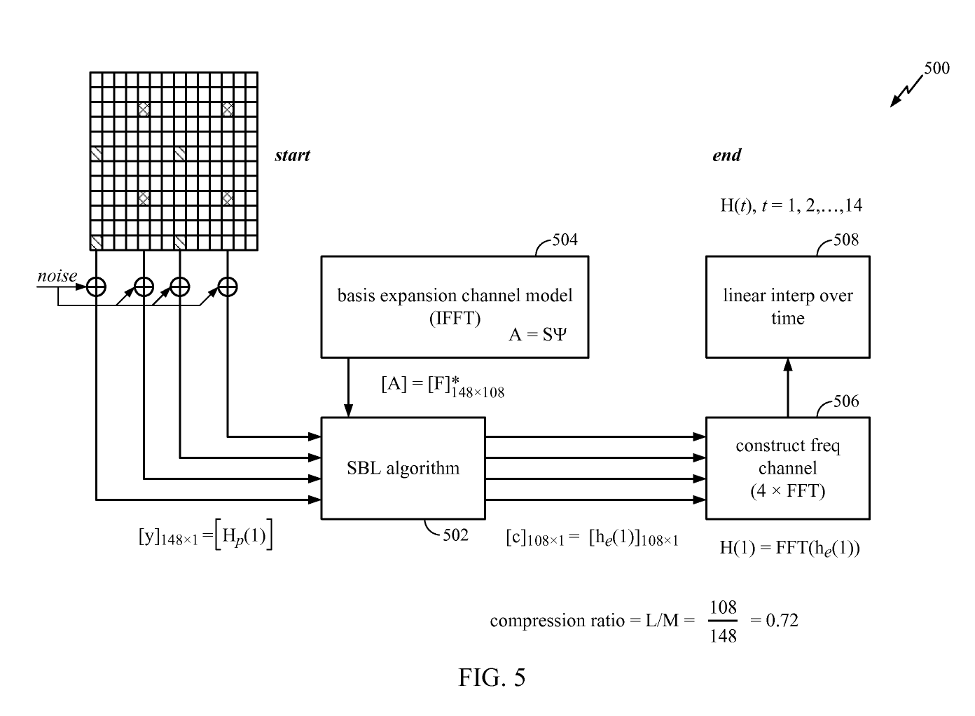

FIG. 5 illustrates another example block diagram 500 of the sparse channel estimation algorithm. The sparse channel estimation algorithm may operate on a single pilot OFDM symbol at a time. Similar to the block diagram in FIG. 4, the SBL algorithm 502 may operate on a measurement vector y to generate the desired coefficients c. The SBL algorithm may utilize a basis expansion channel model 504 along with inverse Fourier transform (IFFT). These coefficients may be used to construct a frequency-domain channel estimation 506. Linear interpolation 508 may be performed over time to generate the final channel estimation H(t).

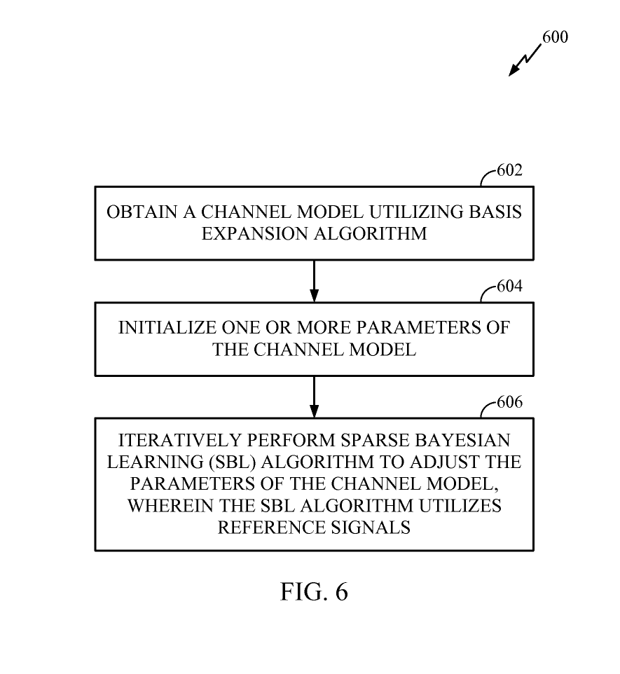

FIG. 6 illustrates example operations 600 for the proposed SBL channel estimation algorithm, in accordance with certain aspects of the present disclosure. At 602, a channel model utilizing basis expansion algorithm may be obtained. At 604, one or more parameters of the channel model may be initialized.

For example, the parameters may be initialized with one or more values obtained from a previous iteration of the SBL algorithm, or a set of constant values. The parameters may also be initialized with initial values obtained from other available channel estimation methods, such as MMSE. At 606, Sparse Bayesian Learning (SBL) algorithm may be performed iteratively to adjust the parameters of the channel model. The SBL algorithm may utilize a plurality of reference signals.

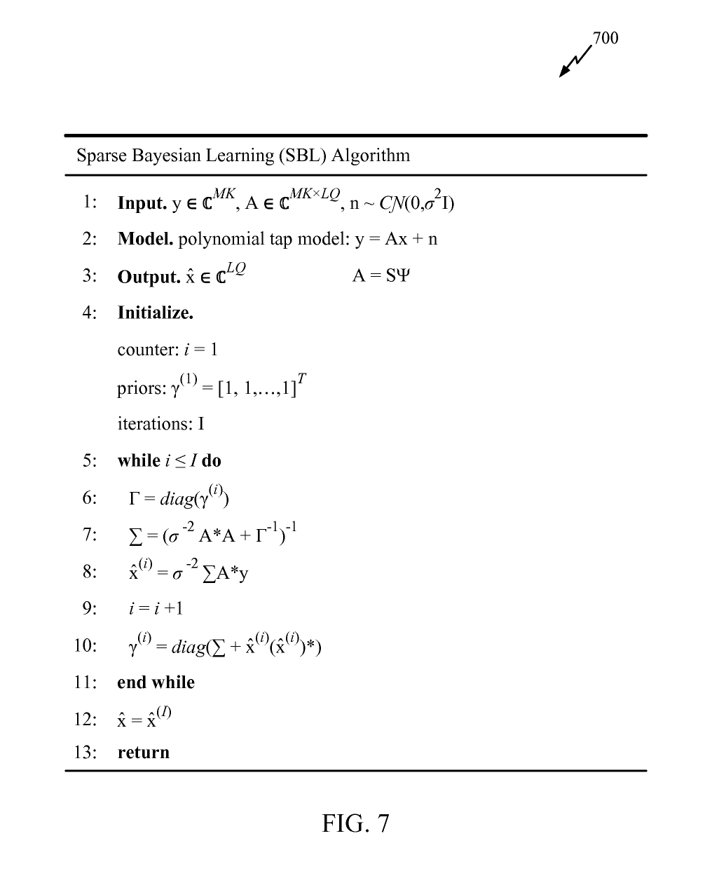

FIG. 7 illustrates the SBL algorithm 700, in accordance with certain aspects of the present disclosure. The algorithm utilizes a polynomial Tap model, y=Ax+n as described in Eqn (4), in which x may represent the channel vector. Noise n may have a normal distribution with zero mean and variance σ², and A may be equal to SΨ. The algorithm starts by selecting a set of prior values γ⁽¹⁾=[1,1, . . . , 1]^{T}. It should be noted that the prior values may be any value other than one, such as prior information obtained from other channel estimation methods, such as MMSE. For I iterations, the following values may be calculated:

Γ=diag(γ⁽ⁱ⁾),

Σ=(σ⁻²A*A+Γ⁻¹)⁻¹,

\hat{x}⁽ⁱ⁾=σ⁻²ΣA*y.

In which Σ is a covariance matrix. After estimating the channel, at the end of each iteration, the prior values may be updated as follows:

γ⁽ⁱ⁾=diag(Σ+\hat{x}⁽ⁱ⁾(\hat{x}⁽ⁱ⁾)*).

The estimated channel may be value of \hat{x} after I iterations (e.g., \hat{x}=\hat{x}^{(I)}).

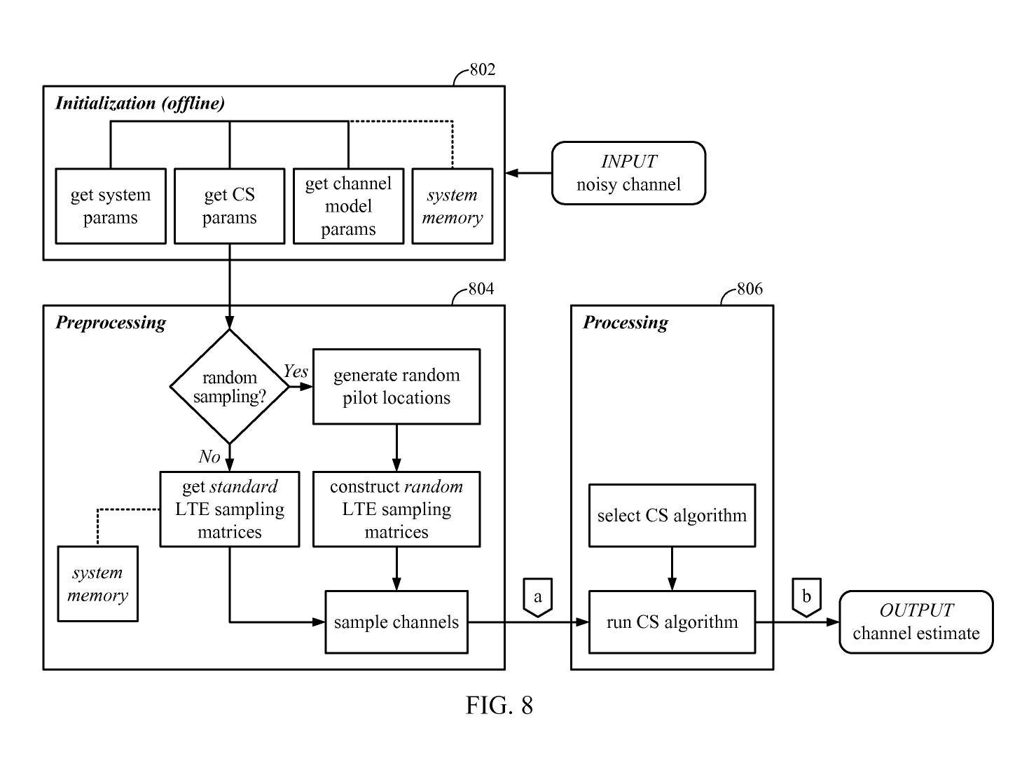

FIG. 8 illustrates an example block diagram 800 of the proposed SBL channel estimation algorithm, in accordance with certain aspects of the present disclosure. At 802, one or more parameters (e.g., system parameters, compressed sensing parameters or channel model parameters) of the channel estimation algorithm may be initialized. At 804, preprocessing may be performed by selecting a sampling matrix from system memory (or generating a random sampling matrix), and sampling the channel. The processing step 806 may perform SBL channel estimation (e.g., sparse recovery or compressed sensing (CS)) using the samples.

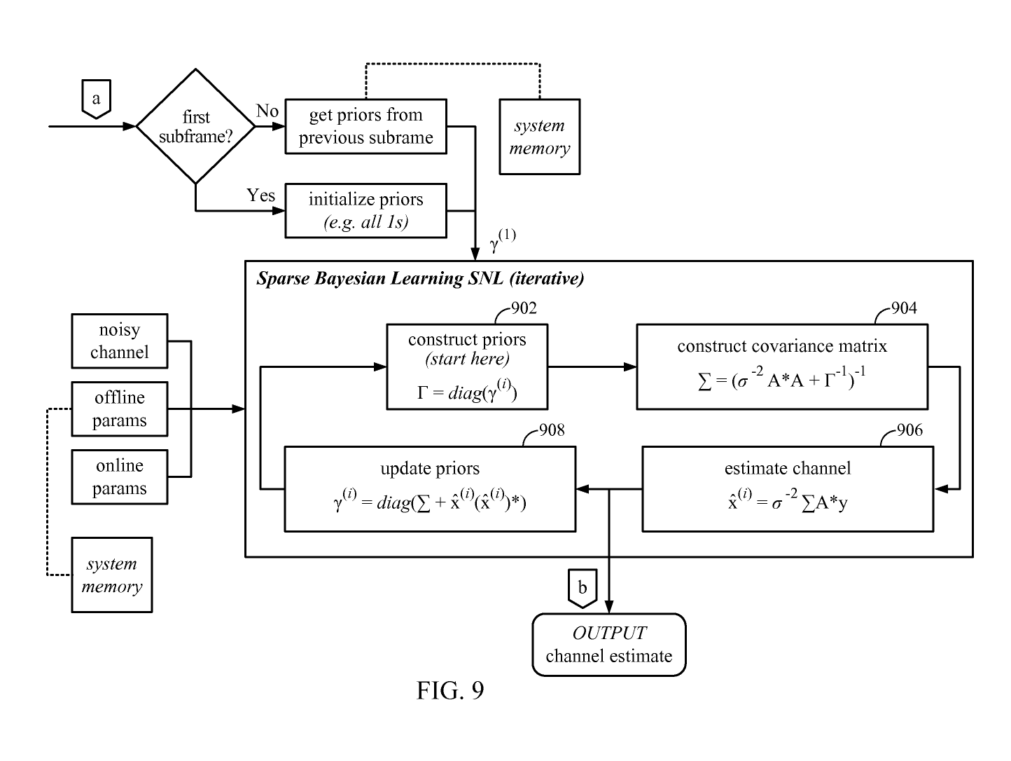

FIG. 9 illustrates the processing step (e.g., block 806) of the proposed SBL channel estimation algorithm in more detail, in accordance with certain aspects of the present disclosure. As illustrated, for the first subframe, the prior values (902) may be set to some constant values, or the prior values may be obtained from other channel estimation algorithms, such as the MMSE algorithm. For subframes other than the first subframe, the prior values may be obtained from the previous subframe.

A covariance matrix 904 may be constructed utilizing the prior values. The channel estimate 906 may be calculated and the priors may be updated 808 before the next iteration. It should be noted that one or more values may be updated in each iteration of the SBL algorithm. The channel estimation may be sent out after some or all of the coefficients are updated.

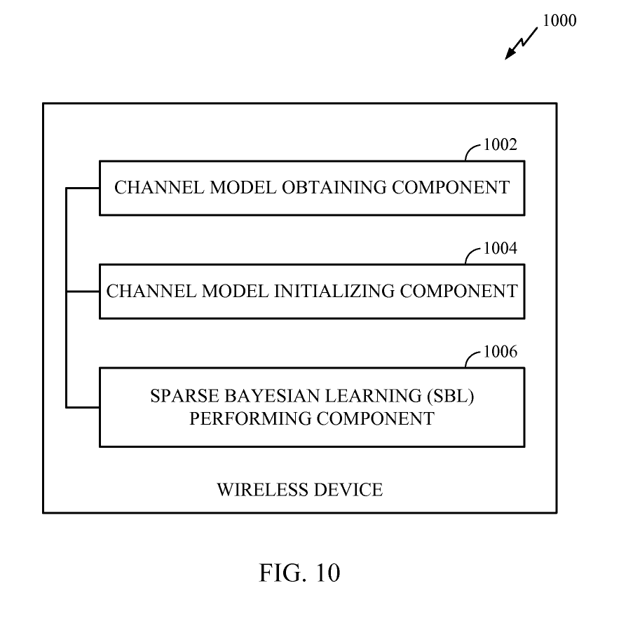

FIG. 10 illustrates an example functional block diagram 1000 of a wireless device capable of performing SBL channel estimation, in accordance with certain aspects of the present disclosure. The device may comprise a channel model obtaining component 1002 for obtaining a channel model such as a Tap polynomial model, a channel model initializing component 1004 for initializing parameters of the channel model, and an SBL performing component 1006 for estimating the channel using SBL algorithm.

The various operations of methods described above may be performed by various hardware and/or software component(s) and/or module(s) corresponding to means-plus-function blocks illustrated in the Figures. For example, means for obtaining may comprise any suitable component capable of obtaining a channel model, such as the channel model obtaining component 1002. Means for initializing the channel model may comprise a circuit or a processor capable of initializing the channel model, such as the channel model initializing component 1004. Means for performing the SBL channel estimation algorithm may comprise a circuit or a processor capable of performing SBL channel estimation, such as the SBL performing component 1006. The SBL performing component 1006 may also comprise means for stacking two or more of the reference signals, means for generating a covariance matrix, means for estimating the channel, and means for updating the parameters of the channel model.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to embodiments of the present disclosure, other and further embodiments of the disclosure may be devised without departing from the basic scope thereof, and the scope thereof is determined by the claims that follow.

What is claimed is:

1. A method for estimating a channel in a wireless communications system, comprising:
obtaining a channel model utilizing basis expansion algorithm;
initializing one or more parameters of the channel model; and
iteratively performing Sparse Bayesian Learning (SBL) algorithm to adjust the parameters of the channel model, wherein the SBL algorithm utilizes reference signals.

2. The method of claim 1, wherein performing the SBL algorithm comprises:
performing the SBL algorithm utilizing a subset of the reference signals.

3. The method of claim 2, wherein one or more reference signals in the subset are selected randomly.

4. The method of claim 2, wherein one or more reference signals in the subset are selected in the order the reference signals are received.

5. The method of claim 1, wherein performing the SBL algorithm comprises:
performing the SBL algorithm utilizing all available reference signals.

6. The method of claim 1, wherein performing the SBL algorithm comprises:
stacking two or more of the reference signals to generate a block of reference signals; and
performing the SBL algorithm utilizing the block of reference signals.

7. The method of claim 1, wherein performing the SBL algorithm comprises:
performing the SBL algorithm utilizing a single reference signal at a time.

8. The method of claim 7, further comprising:
performing linear interpolation on the parameters of the channel model.

9. The method of claim 1, wherein initializing the parameters of the channel model comprises:
initializing the parameters with one or more values obtained from a previous iteration of the SBL algorithm.

10. The method of claim 1, wherein initializing the parameters of the channel model comprises:
initializing the parameters with one or more constant values.

11. The method of claim 1, wherein initializing the parameters of the channel model comprises:
initializing the parameters with initial values obtained from another channel estimation algorithm.

12. The method of claim 1, wherein the channel model is a Tap Polynomial Model.

13. The method of claim 1, wherein performing the SBL algorithm comprises:
generating a covariance matrix utilizing the parameters of the channel model; and
estimating the channel utilizing the covariance matrix.

14. The method of claim 13, further comprising:
updating the parameters of the channel model utilizing the estimated channel.

15. The method of claim 1, wherein the channel is a communication channel utilized in an orthogonal frequency division multiplexing (OFDM) system.

16. An apparatus for estimating a channel in a wireless communications system, comprising:
means for obtaining a channel model utilizing basis expansion algorithm;
means for initializing one or more parameters of the channel model; and
means for iteratively performing Sparse Bayesian Learning (SBL) algorithm to adjust the parameters of the channel model, wherein the SBL algorithm utilizes reference signals.

17. The apparatus of claim 16, wherein the means for performing the SBL algorithm comprises:
means for performing the SBL algorithm utilizing a subset of the reference signals.

18. The apparatus of claim 17, wherein one or more reference signals in the subset are selected randomly.

19. The apparatus of claim 17, wherein one or more reference signals in the subset are selected in the order the reference signals are received.

20. The apparatus of claim 16, wherein the means for performing the SBL algorithm comprises:
means for performing the SBL algorithm utilizing all available reference signals.

21. The apparatus of claim 16, wherein the means for performing the SBL algorithm comprises:
means for stacking two or more of the reference signals to generate a block of reference signals; and
means for performing the SBL algorithm utilizing the block of reference signals.

22. The apparatus of claim 16, wherein the means for performing the SBL algorithm comprises:
means for performing the SBL algorithm utilizing a single reference signal at a time.

23. The apparatus of claim 22, further comprising:
means for performing linear interpolation on the parameters of the channel model.

24. The apparatus of claim 16, wherein the means for initializing the parameters of the channel model comprises:
means for initializing the parameters with one or more values obtained from a previous iteration of the SBL algorithm.

25. The apparatus of claim 16, wherein the means for initializing the parameters of the channel model comprises:
means for initializing the parameters with one or more constant values.

26. The apparatus of claim 16, wherein the means for initializing the parameters of the channel model comprises:
means for initializing the parameters with initial values obtained from another channel estimation algorithm.

27. The apparatus of claim 16, wherein the channel model is a Tap Polynomial Model.

28. The apparatus of claim 16, wherein the means for performing the SBL algorithm comprises:
means for generating a covariance matrix utilizing the parameters of the channel model; and
means for estimating the channel utilizing the covariance matrix.

29. The apparatus of claim 28, further comprising:
means for updating the parameters of the channel model utilizing the estimated channel.

30. The apparatus of claim 16, wherein the channel is a communication channel utilized in an orthogonal frequency division multiplexing (OFDM) system.

31. A computer-program product for estimating a channel in a wireless communications system, comprising a computer readable medium having instructions stored thereon, the instructions being executable by one or more processors and the instructions comprising:
instructions for obtaining a channel model utilizing basis expansion algorithm;
instructions for initializing one or more parameters of the channel model; and
instructions for iteratively performing Sparse Bayesian Learning (SBL) algorithm to adjust the parameters of the channel model, wherein the SBL algorithm utilizes reference signals.

32. An apparatus for estimating a channel in a wireless communications system, comprising:
at least one processor configured to obtain a channel model utilizing basis expansion algorithm, initialize one or more parameters of the channel model, and iteratively perform Sparse Bayesian Learning (SBL) algorithm to adjust the parameters of the channel model, wherein the SBL algorithm utilizes reference signals; and
a memory coupled to the at least one processor.
